(19) United States
(12) Patent Application Publication
(10) Pub. No.: US 2016/0303518 A1
(43) Pub. Date: Oct. 20, 2016

(54) NANOCOMPOSITE ULTRAFILTRATION MEMBRANE CONTAINING GRAPHENE OXIDE OR REDUCED GRAPHENE OXIDE AND PREPARATION METHOD THEREOF

(71) Applicant: KOREA RESEARCH INSTITUTE OF CHEMICAL TECHNOLOGY, Daejeon (KR)

(72) Inventors: Saira BANO, Lahore (PK); Asif MAHMOOD, Daejeon (KR); Seong-Joong Kim, Daejeon (KR); Kew Ho Lee, Daejeon (KR)

(73) Assignee: KOREA RESEARCH INSTITUTE OF CHEMICAL TECHNOLOGY, Daejeon (KR)

(21) Appl. No.: 15/064,280

(22) Filed: Mar. 8, 2016

(30) Foreign Application Priority Data
Apr. 15, 2015 (KR) 10-2015-0053429

(51) Int. Cl. B01D 71/42; B01D 69/12; B01D 67/00; B01D 61/14

(52) U.S. Cl. CPC B01D 71/42; B01D 61/145; B01D 69/12; B01D 67/0011; B01D 67/0013

(57) ABSTRACT

Provided is a nanocomposite ultrafiltration membrane including a hydrophobic polymer matrix impregnated with graphene oxide or reduced graphene oxide. The PAN/GO nanocomposite ultrafiltration membrane has improved mechanical properties, high permeability and a high salt rejection ratio, and excellent anti-fouling property and durability. Thus, the nanocomposite ultrafiltration membrane may be manufactured in the form of a membrane module applied to a water treatment system so that it may be utilized in an actual ultrafiltration separation process.

### CROSS-REFERENCE TO RELATED APPLICATIONS

This application claims priority under 35 U.S.C. §119 to Korean Patent Application No. 10-2015-0053429 filed on Apr. 15, 2015 in the Korean Intellectual Property Office, the disclosure of which is incorporated herein by reference in its entirety.

### TECHNICAL FIELD

The following disclosure relates to a nanocomposite ultrafiltration membrane including graphene oxide or reduced graphene oxide and a method for preparing the same. More particularly, the following disclosure relates to preparation of a nanocomposite ultrafiltration membrane including impregnation of a hydrophobic polymer matrix with graphene oxide or reduced graphene oxide, and application of the nanocomposite ultrafiltration membrane to water treatment industry.

### BACKGROUND

In general, it is required in a separation membrane process that a membrane has a dense structure in order to separate macromolecules from aqueous solution. This results in an increase in hydrodynamic resistance. Herein, when the applied pressure is higher and the pore size of a membrane is smaller as compared to those in a microfiltration (MF) process, the corresponding process is referred to as an ultrafiltration (UF) process. Since such an ultrafiltration process has been grown continuously approximately for the last ten years in various industrial fields, including pharmaceutical industry, waste water treatment industry and reverse osmosis-based pretreatment industry, the chemical properties of a membrane have been important factors determining the quality and use of an ultrafiltration process.

Meanwhile, it is possible to separate low-molecular weight ingredients having a similar size by using an asymmetric membrane having a dense structure through a reverse osmosis process. However, such a separation process requires very high pressure, resulting in a significant increase in hydrodynamic pressure. Thus, an ultrafiltration process that may be driven under lower pressure as compared to a reverse osmosis process still has been used. However, it is difficult to minimize concentration polarization and membrane fouling in such an ultrafiltration process (Patent Document 1).

Meanwhile, it is known that graphene is a two-dimensional material of a nanoplate structure including a single carbon atom layer having a hexagonal honeycomb-like shape, shows excellent physicochemical properties, and has high mechanical strength although it is a single atom layer. However, in the case of the polymer composites including graphene or graphene oxide according to the related art, dispersibility and compatibility between graphene or graphene oxide and the polymer are low, resulting in a limitation in commercialization (Non-Patent Document 1).

Particularly, there have been an attempt to prepare a polypyrrole/hydrolyzed polyacrylonitrile-based composite containing graphene oxide so that it may be applied to a solvent-resistant nanofiltration membrane (Non-Patent Document 2), and another attempt to prepare a polyacrylonitrile/montmorillonite composite membrane containing graphene oxide so that it may be applied to a biocatalyst/adsorption process (Non-Patent Document 3). However, such applications are limited and the composites are not suitable for application to a separation membrane process in general water treatment field.

Under these circumstances, the inventors of the present disclosure have found that preparation of a composite membrane with a hydrophobic polymer including graphene oxide or reduced graphene oxide provides the composite membrane with significantly improved hydrophilicity, permeability and mechanical properties by virtue of the incorporation of graphene oxide, and the composite membrane shows an enhanced effect of preventing membrane fouling and significantly improved long-term durability, and thus may be applied to industrial fields to which an ultrafiltration process is utilized actually. The present disclosure is based on this finding.

### REFERENCES

### Patent Document

Patent Document 1. Korean Patent Publication No. 10-1292485

### Non-Patent Document

Non-Patent Document 1. Hyunwoo Kim et al., Macromolecules, 43, 6515-6530(2010)
Non-Patent Document 2, Lu Shao et al., J. Membr. sci. 452, 82-89(2014)
Non-Patent Document 3. Qingqing Wang et al., Molecules, 19, 3376-3388(2014)

### SUMMARY

An embodiment of the present disclosure is directed to providing a nanocomposite ultrafiltration membrane including graphene oxide or reduced graphene oxide which has improved mechanical properties, high permeability and a high salt rejection ratio and shows excellent anti-fouling property and durability, as well as a method for preparing the same.

In one aspect, there is provided a nanocomposite ultrafiltration membrane, including: a hydrophobic polymer matrix; and graphene oxide or reduced graphene oxide.

According to an embodiment, the hydrophobic polymer is any one selected from the group consisting of polyacrylonitrile, polysulfone, polyethersulfone, polyimide, polyetherimide, polyamide, cellulose acetate, cellulose triacetate and polyvinylidene fluoride.

According to another embodiment, the graphene oxide or reduced graphene oxide is present in an amount of 0.1 wt %-10 wt % based on the total weight of the nanocomposite ultrafiltration membrane.

According to still another embodiment, the graphene oxide is functionalized graphene oxide whose hydroxyl, carboxyl, carbonyl or epoxy group is converted into an ester, ether, amide or amino group.

In another aspect, there is provided a method for preparing a nanocomposite ultrafiltration membrane, including the steps of: I) adding graphene oxide to an organic solvent and carrying out ultrasonication to obtain a homogenous dispersion; II) dissolving a hydrophobic polymer into the dispersion to obtain a casting solution; and III) casting the casting solution onto a substrate and dipping the substrate into a solidification bath to carry out phase transition.

According to an embodiment, the graphene oxide in step I) is functionalized graphene oxide whose hydroxyl, carboxyl, carbonyl or epoxy group is converted into an ester, ether, amide or amino group.

According to another embodiment, the organic solvent in step I) is any one selected from the group consisting of dimethylformamide, dimethylacetamide, N-methylpyrrolidone, dimethyl sulfoxide and a mixture thereof.

According to still another embodiment, the hydrophobic polymer in step II) is any one selected from the group consisting of polyacrylonitrile, polysulfone, polyethersulfone, polyimide, polyetherimide, polyamide, cellulose acetate, cellulose triacetate and polyvinylidene fluoride.

According to still another embodiment, the casting solution in step II) includes graphene oxide in an amount of 0.1 wt %-10 wt %.

According to still another embodiment, the solidification bath in step III) includes at least one non-solvent selected from the group consisting of water, methanol, ethanol, isopropanol and acetone.

According to still another embodiment, the method further includes treating the graphene oxide in step I) chemically or thermally to obtain reduced graphene oxide.

According to yet another embodiment, the chemical treatment of graphene oxide is carried out by reacting graphene oxide with any reducing agent selected from the group consisting of hydrazine, dimethyl hydrazine, sodium borohydride, hydroquinone and hydrogen iodide.

In still another aspect, there is provided a spirally wound type membrane module including the nanocomposite ultrafiltration membrane.

In yet another aspect, there is provided a water treatment system including the spirally wound type membrane module.

The nanocomposite ultrafiltration membrane including graphene oxide or reduced graphene oxide according to the present disclosure has improved mechanical properties and high permeability and a high salt rejection ratio and shows excellent anti-fouling property and durability, and thus may be manufactured in the form of a spirally wound type membrane module for use in a water treatment system and applied to an actual ultrafiltration separation process.

### BRIEF DESCRIPTION OF THE DRAWINGS

FIG. 1 is a schematic view illustrating the hydrogen bonding interaction between nitrile groups of polyacrylonitrile (PAN) and graphene oxide (GO).

FIG. 2 shows the spectrum of a PAN membrane and that of PAN/GO-2.0 as determined by Fourier Transform Infrared Spectroscopy (FTIR).

FIG. 3 shows the spectrum of a PAN membrane and that of PAN/GO-2.0 as determined by Raman Spectroscopy.

FIG. 4A shows the transmission electron microscopic (TEM) image of GO.

FIG. 4B shows the transmission electron microscopic (TEM) image of a PAN/GO-2.0 nanocomposite membrane.

FIG. 5A shows the scanning electron microscopic (SEM) image of the surface of a PAN membrane at 500 nm.

FIG. 5B shows the scanning electron microscopic (SEM) image of the surface of a PAN/GO-2.0 nanocomposite membrane at 500 nm.

FIG. 5C shows the scanning electron microscopic (SEM) image a section of a PAN membrane at 20 μm.

FIG. 5D shows the scanning electron microscopic (SEM) image a section of a PAN/GO-2.0 nanocomposite membrane at 20 μm.

FIG. 6A shows the surface image of a PAN membrane.

FIG. 6B shows the surface image of PAN/GO-2.0 nanocomposite membrane as determined by Atomic Force Microscopy (AFM).

FIG. 7 is a graph illustrating the effect of GO upon a permeation flux and a salt rejection ratio (feed=pure water and 1000 ppm BSA (bovine serum albumin) solution dissolved in PBS (phosphate buffer saline), operating pressure=1 bar).

FIG. 8 is a graph illustrating the water permeation flux recovery ratio (FRR) of a PAN membrane and that of a FAN/GO nanocomposite membrane (operating pressure=1 bar).

FIG. 9 is a graph illustrating the effect of GO upon a normalized permeation flux in a PAN membrane and PAN/GO nanocomposite membrane as a function of operating time (feed=pure water and 1000 ppm BSA (bovine serum albumin) solution dissolved in PBS), operating pressure=1 bar).

FIG. 10 is a graph showing the results of filtration resistance analysis for a PAN membrane and PAN/GO nanocomposite membrane.

FIG. 11 is a graph illustrating the effect of GO upon the electrostatic BSA adsorption in a PAN membrane and FAN/GO nanocomposite membrane.

FIG. 12 is a graph illustrating a change in permeation flux of a PAN membrane and that of a FAN/GO nanocomposite membrane as a function of time, when carrying out ultrafiltration of a BSA solution three times in one cycle.

FIG. 13 is a graph showing the tensile strength and elongation at break of a PAN membrane and those of a PAN/GO nanocomposite membrane.

### DETAILED DESCRIPTION OF EMBODIMENTS

The advantages, features and aspects of the nanocomposite ultrafiltration membrane including graphene oxide or reduced graphene oxide and the method for preparing the same according to the present disclosure will become apparent from the following description of the embodiments with reference to the accompanying drawings, which is set forth hereinafter.

In one aspect, there is provided a nanocomposite ultrafiltration membrane, including: a hydrophobic polymer matrix; and graphene oxide or reduced graphene oxide.

In the case of the polymer composite including graphene or graphene oxide (GO) according to the related art, the dispersibility and compatibility between graphene or graphene oxide and a polymer are low, and thus the commercialization of such polymer composites is limited. Particularly, it almost never have happened that such polymer composites are manufactured in the form of a membrane to be applied to an ultrafiltration process. However, according to the present disclosure, a hydrophobic polymer matrix is impregnated with graphene oxide or reduced graphene oxide to obtain a nanocomposite membrane through a phase transition method, and the obtained nanocomposite membrane is applied to an ultrafiltration process in which it shows excellent separation quality.

In general, when using a hydrophilic polymer is used as a material for an ultrafiltration membrane, water molecules contained in the membrane function as a plasticizer during a permeation process so that the thermal stability and mechanical strength of the membrane are degraded, resulting in significant degradation of durability. Thus, such hydrophilic polymers are not suitable as materials for ultrafiltration membranes. This is because the present disclosure uses a hydrophobic polymer as a matrix material forming an ultrafiltration composite membrane.

Particularly, as the hydrophobic polymer, any one selected from the group consisting of polyacrylonitrile (PAN), polysulfone (PSF), polyethersulfone (PES), polyimide (PI), polyetherimide (PEI), polyamide (PA), cellulose acetate (CA), cellulose triacetate (CTA) and polyvinylidene fluoride (PVDF) may be used. More particularly, used is polyacrylonitrile that has excellent chemical stability and is capable of interaction with the hydroxyl groups and carboxyl groups on the graphene oxide surface through hydrogen bonding.

Meanwhile, an ultrafiltration membrane including a hydrophobic polymer alone is susceptible to fouling. Thus, according to the present disclosure, a hydrophobic polymer matrix is impregnated with graphene oxide or reduced graphene oxide to enhance hydrophilic property and to control the roughness of the membrane surface so that the anti-fouling property may be improved.

Graphene oxide used herein may be prepared in a great amount by oxidizing graphite with an oxidant, and contains a hydrophilic functional group, such as hydroxyl, carboxyl, carbonyl or epoxy group. Recently, graphene oxide has been prepared largely according to the Hummers' method [Hummers, W. S. & Offeman, R. E. Preparation of graphite oxide. J. Am. Chem. Sac, 80, 1339 (1958)] or a partially modified Hummers' method. According to the present disclosure, graphene oxide is obtained by a modified Hummers' method.

In addition, graphene oxide may be functionalized graphene oxide in which the hydrophilic functional group, such as hydroxyl, carboxyl, carbonyl or epoxy group, chemically reacts with another compound to be converted into an ester, ether, amide or amino group. For example, such functionalized graphene oxide may include one in which a carboxyl group of graphene oxide reacts with an alcohol to be converted into an ester group, a hydroxyl group of graphene oxide reacts with an alkyl halide to be converted into an ether group, a carboxyl group of graphene oxide reacts with an alkyl amine to be converted into an amide group, or an epoxy group of graphene oxide is subjected to ring opening with an alkyl amine to be converted into an amino group. Further, according to the present disclosure, it is also possible to use reduced graphene oxide (rGO) obtained by reducing graphene oxide through a known chemical or thermal reduction process.

Particularly, graphene oxide or reduced graphene oxide is present in an amount of 0.1 wt %-10 wt % based on the weight of the nanocomposite ultrafiltration membrane. When graphene oxide or reduced graphene oxide is present in an amount less than 0.1 wt %, hydrophilic property and mechanical properties may not be improved sufficiently and anti-fouling property may be degraded. When graphene oxide or reduced graphene oxide is present in an amount greater than 10 wt %, it is difficult to disperse graphene oxide or reduced graphene oxide homogenously in a hydrophobic polymer matrix and to control the morphology, resulting in fouling of the membrane and degradation of a permeation flux and salt rejection ratio.

In another aspect, there is provided a method for preparing a nanocomposite ultrafiltration membrane, including the steps of: I) adding graphene oxide to an organic solvent and carrying out ultrasonication to obtain a homogenous dispersion; II) dissolving a hydrophobic polymer into the dispersion to obtain a casting solution; and III) casting the casting solution onto a substrate and dipping the substrate into a solidification bath to carry out phase transition.

The graphene oxide in step I) is obtained by a modified Hummers' method as mentioned above, and may be functionalized graphene oxide whose hydroxyl, carboxyl, carbonyl or epoxy group is converted into an ester, ether, amide or amino group.

In addition, in step I), ultrasonication may be carried out after adding graphene oxide into the organic solvent to obtain a homogenous dispersion having improved dispersibility. Herein, any one of various solvents, such as polar or non-polar solvents, may be used as the organic solvent depending on the particular type of hydrophobic polymer. Particularly, a polar aprotic solvent used widely as a solvent for general polymers, such as a solvent selected from the group consisting of dimethyl formamide (DMF), dimethyl acetamide (DMAc), N-methyl pyrrolidone (NMP), dimethyl sulfoxide (DMSO) or a mixture thereof, may be used.

Further, the hydrophobic polymer in step II) is any one selected from the group consisting of polyacrylonitrile, polysulfone, polyethersulfone, polyimide, polyetherimide, polyamide, cellulose acetate, cellulose triacetate and polyvinylidene fluoride. Particularly, used is polyacrylonitrile that has excellent chemical stability and is capable of interaction with hydroxyl and carboxyl groups on the graphene oxide surface through hydrogen bonding.

In addition, the casting solution in step II) includes graphene oxide in an amount controlled to 0.1 wt %-10 wt %, considering the physical properties, separation quality and easy film-forming property of the desired nanocomposite ultrafiltration membrane.

Further, in step III), after the casting solution is cast onto the support, dipping into the solidification bath is carried out to form an asymmetric membrane through phase transition. The solidification bath may include at least one non-solvent selected from the group consisting of water, methanol, ethanol, isopropanol and acetone. Particularly, water is used so that an asymmetric membrane may be formed by a non-solvent induced phase separation process in which phase transition occurs based on solvent/non-solvent exchange.

The method may further include treating the graphene oxide in step I) chemically or thermally to obtain reduced graphene oxide. The obtained reduced graphene oxide may be subjected to step I)-step III) in the same manner as described above to obtain a nanocomposite ultrafiltration membrane. Herein, the chemical treatment of graphene oxide for preparing reduced graphene oxide is carried out by reacting graphene oxide with any reducing agent selected from the group consisting of hydrazine, dimethyl hydrazine, sodium borohydride, hydroquinone and hydrogen iodide under known reaction conditions.

In still another aspect, there is provided a spirally wound type membrane module including the nanocomposite ultrafiltration membrane. The spirally wound type membrane module may be incorporated to a water treatment system that may be applied to an actual ultrafiltration process.

The examples and experiments will now be described. The following examples and experiments are for illustrative purposes only and not intended to limit the scope of this disclosure.

### Example

### Preparation of PAN/GO Nanocomposite Ultrafiltration Membrane

First, graphene oxide (GO) obtained by the known modified Hummers' method is added to dimethyl formamide and ultrasonication is carried out for 1 hour to obtain a homogenous dispersion. Polyacrylonitrile (PAN) is dissolved into the dispersion at 70° C. to a concentration of 20 and the mixture is agitated for 12 hours and subjected to ultrasonication for 1 hour to obtain homogenous casting solutions (4 types of casting solutions each having a graphene oxide content of 0.5 wt %, 1.0 wt %, 1.5 wt % and 2.0 wt %). Each of the casting solutions is cast onto a substrate that is a glass plate having a polyester non-woven web attached thereto by using a doctor blade to a knife gap of 200 μm. Then, the substrate is dipped into a solidification bath containing water at 20° C. to carry out phase transition. After that, the remaining solvent is removed and dried to obtain a PAN/GO nanocomposite membrane. The obtained 4 types of PAN/GO nanocomposite membranes are designated as PAN/GO-0.5, PAN/GO-1.0, PAN/GO-1.5 and PAN/GO-2.0 according to graphene oxide content.

### Comparative Example

### Preparation of PAN Membrane

A pure PAN membrane containing no graphene oxide is obtained through a phase transition process in the same manner as the above Example, except that impregnation of polyacrylonitrile with graphene oxide is not carried out.

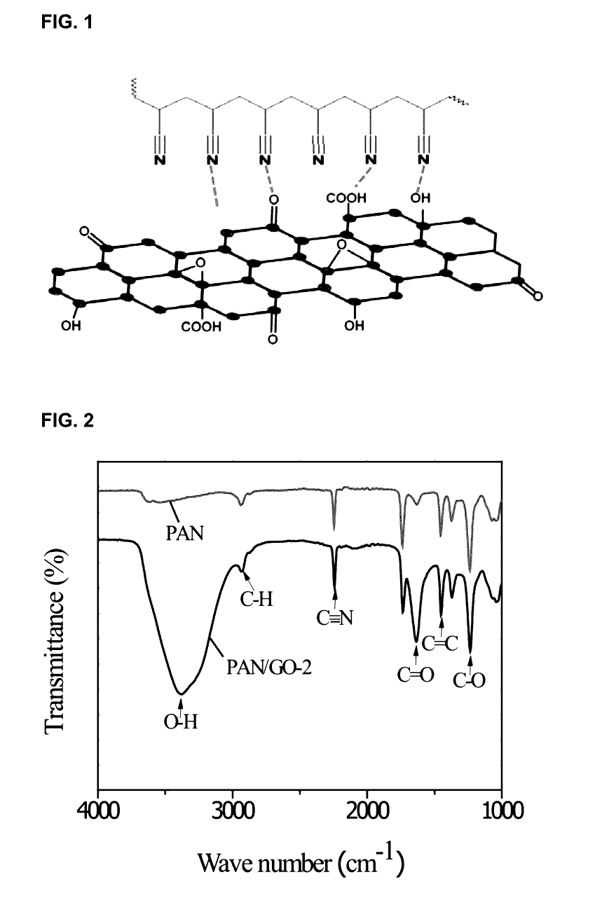

The schematic view of FIG. 1 illustrates the interaction between nitrile groups of polyacrylonitrile (PAN) and graphene oxide (GO) through hydrogen bonding. Such interaction is determined by FIG. 2 that shows the spectrum of a PAN membrane and that of PAN/GO-2.0 obtained by Fourier Transform Infrared Spectroscopy (FTIR).

In the spectrum of pure PAN, the most significant characteristics are the nitrile (—CN) absorption peak at 2245 cm⁻¹, C—H stretching peak at 2919 cm⁻¹, and deformation peak at 1455 cm⁻¹. The strong peak that appears at 3380 cm⁻¹ in the spectrum of PAN/GO-2.0 nanocomposite membrane suggests the presence of a hydroxyl (—OH) group, which enhances the hydrophilicity of the membrane surface. In addition, an increase in intensity of the carboxyl group peak at 1634 cm⁻¹ in the PAN/GO-2.0 nanocomposite membrane may be related with the bonding of carboxyl group with GO. Although the unique PAN peaks are observed also in the PAN/GO-2.0 nanocomposite membrane, they are shifted slightly toward the longer wavelength (2240 cm⁻¹) side. This suggests that hydrogen bonding is formed between the nitrile groups of PAN and hydroxyl/carboxyl groups of GO.

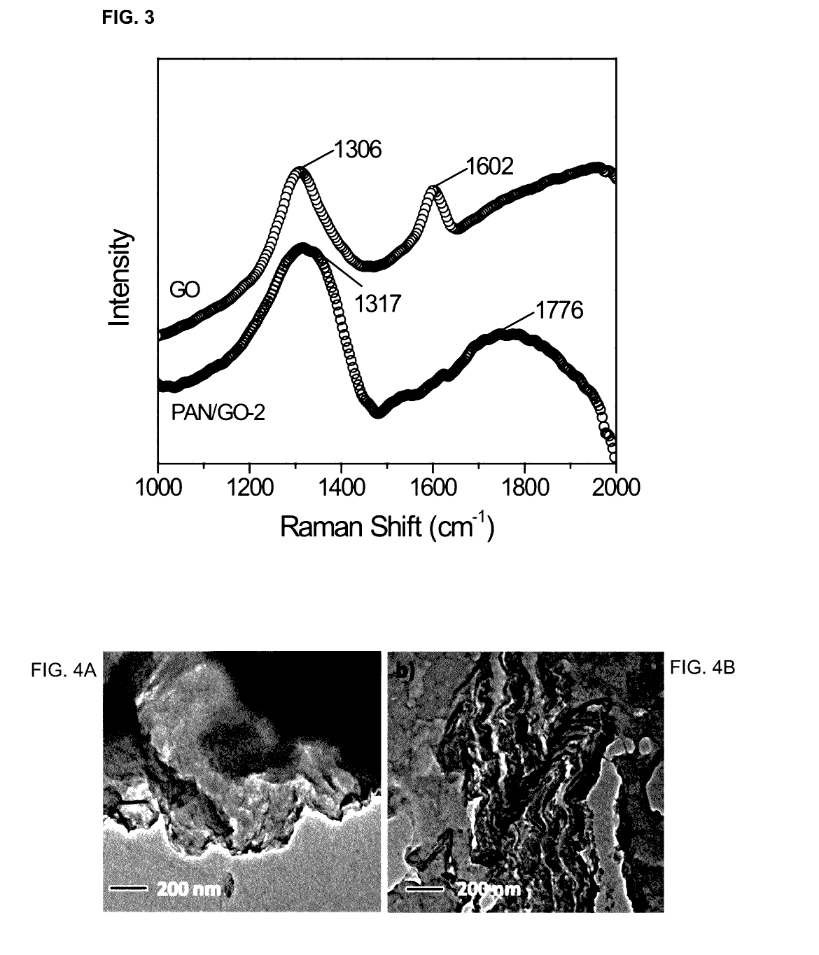

In addition, Raman spectroscopy is used to investigate the interaction between the polymer matrix and GO in detail. It is shown by Raman spectroscopy that GO is present on the PAN membrane and interaction is made between them. As shown in FIG. 3 illustrating the Raman spectrum of a PAN membrane and that of PAN/GO-2.0 GO shows characteristic peaks corresponding to D band and G band at 1306 cm⁻¹ and 1602 cm⁻¹, respectively. Although such characteristic peaks also appear in the PAN/GO-2.0 nanocomposite membrane, D band and G band are shifted to 1317 cm⁻¹ and 1776 cm⁻¹, respectively, toward the longer wavelength side. It is thought that the broadening of G band results from the interlayer separation of GO sheets and dispersion thereof into the PAN polymer matrix.

In addition, FIG. 4A shows transmission electron microscopic (TEM) image of GO and FIG. 4B shows transmission electron microscopic (TEM) image of a PAN/GO-2.0 nanocomposite membrane in order to determine the effect of GO upon the structure of PAN membrane. Pure GO exists as a laminate of very thin nanosheets. Such nanosheets may include a single layer or multiple layers and have a size of several hundreds nanometers. On the other hand, in the case of the PAN/GO-2.0 nanocomposite membrane, it is shown that GO sheets are dispersed homogenously in the polymer matrix and no agglomeration is observed. Such results are supported by Raman spectroscopy, which shows that GO is dispersed well in a single sheet.

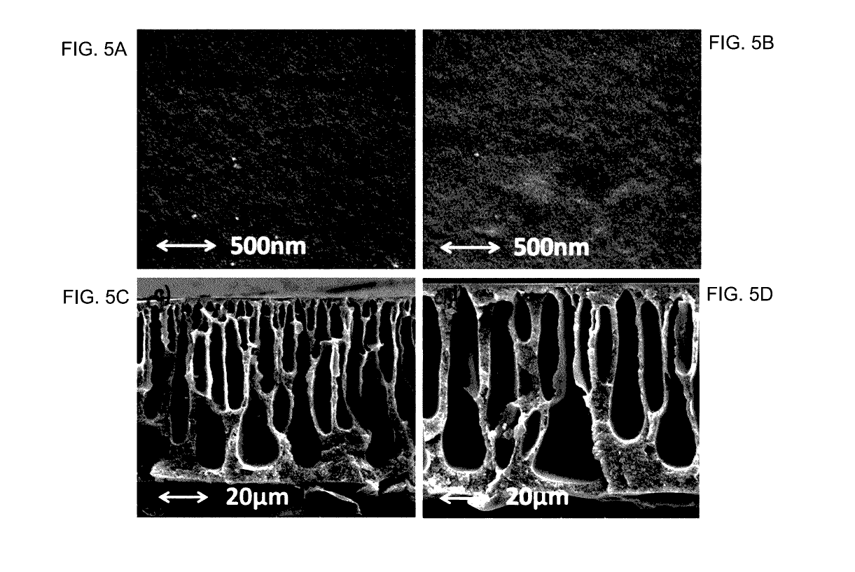

In addition, FIG. 5A shows a scanning electron microscopic (SEM) image of the surface at 500 nm and FIG. 50 shows a SEM image of a section of a PAN membrane at 20 μm, while and FIG. 5B shows a SEM image of the surface at 500 nm and FIG. 5d shows a SEM image of section of a PAN/GO-2.0 nanocomposite membrane at 20 μm. The surface structure shows little change after the addition of GO. As shown in of FIG. 5B, the surface is relatively smooth and agglomeration of GO is not observed like the other carbonaceous nanomaterials. GO is dispersed well in the polymer matrix by virtue of its carbonaceous structure. In addition, no significant cracking is observed on the membrane surface, suggesting that the membrane shows no brittleness even after the incorporation of GO and has excellent stability. The sectional images of the PAN membrane and PAN/GO-2.0 nanocomposite membrane show a typical asymmetric porous structure having a dense upper layer and a finger-like porous lower layer. As can be seen from the sectional images, the finger-like pores inside GO incorporated to the membrane have a slightly larger width as compared to the initial PAN membrane. Such an increase in porosity suggests that incorporation of GO have a significant effect upon the formation of a membrane, resulting in a change in membrane structure. One of the causes for such an effect is that GO having high hydrophilicity causes rapid exchange between the solvent and non-solvent during the phase transition, thereby increasing the width of finger-like pores inside the nanocomposite membrane.

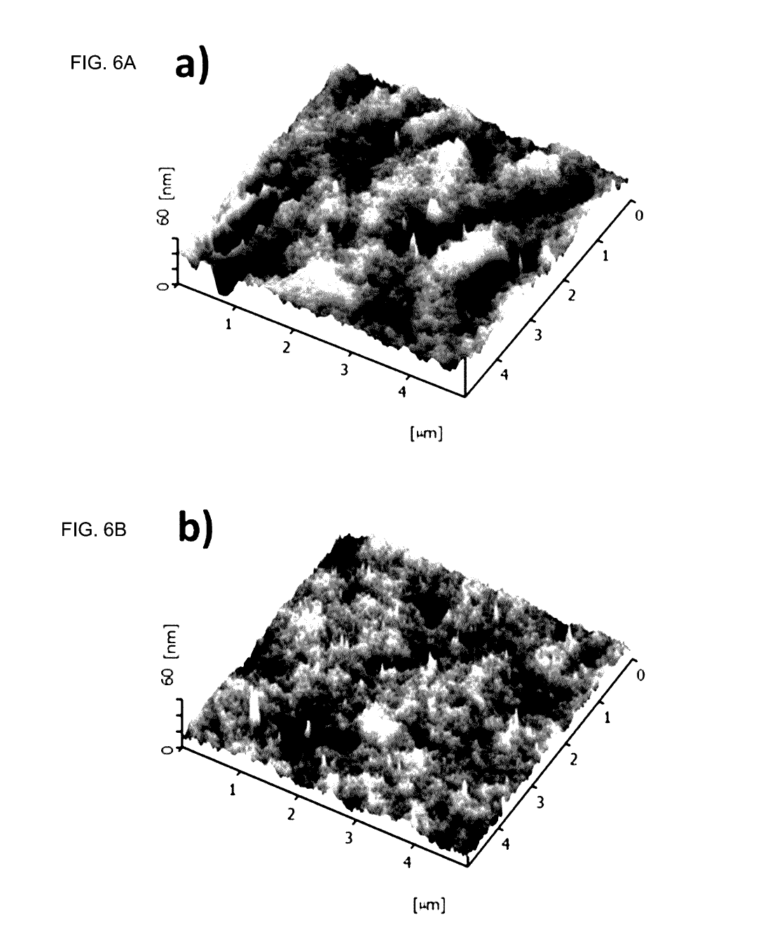

Further, the surface roughness of the PAN membrane and that of the PAN/GO-2.0 nanocomposite membrane are determined by Atomic Force Microscopy (AFM). The structure of a membrane plays an important role in determining the fouling characteristics of the membrane. It is well known that a membrane having a soft surface has high anti-fouling property. FIG. 6A shows the surface image of a PAN membrane and FIG. 6b shows a surface image of a PAN/GO-2.0 nanocomposite membrane as determined by Atomic Force Microscopy (AFM). In the AFM images, the dark portion represents a valley and the light portion represents a ridge. The surface roughness of the PAN membrane is larger than that of the PAN/GO-2.0 nanocomposite membrane. It can be determined that incorporation of GO causes a decrease in sizes of peaks and valleys while making the membrane softer. Thus, it is expected that the PAN/GO-2.0 nanocomposite membrane has higher anti-fouling property as compared to the PAN membrane.

In addition, contact angles are determined to check the improvement of hydrophilicity in the PAN/GO nanocomposite membranes obtained from the above Example. The following Table 1 shows the contact angles, consolidation coefficients, porosities and average pore diameters.

TABLE 1

| | Consolidation | Contact | | Average pore |
|---|---|---|---|---|
| | coefficient (α) | angle | Porosity | diameter |
| Membranes | (bar⁻¹) | (°) | (%) | (nm) |
| PAN | 0.126 | 52 | 60 | 9 ± 3 |
| PAN/GO-0.5 | 0.109 | 49.5 | 60.5 | 10 ± 1 |
| PAN/GO-1.0 | 0.102 | 47.2 | 61.0 | 11 ± 2 |
| PAN/GO-1.5 | 0.0998 | 43.8 | 64.5 | 11.5 ± 1 |
| PAN/GO-2.0 | 0.0971 | 40 | 68 | 12 ± 2 |

It can be seen from the consolidation coefficient values of Table 1 that the PAN membrane shows a higher consolidation effect as compared to the PAN/GO nanocomposite membrane. In the case of the FAN/GO-2.0 nanocomposite membrane, it has a consolidation coefficient about 30% smaller than the consolidation coefficient of the pure PAN membrane. Such behavior is thought to be related with the mechanical stability of a membrane based on the study results according to the related art. As the mechanical stability of a membrane increases, the consolidation coefficient decreases. Meanwhile, the extent of contact angle is one of the parameters showing the hydrophilicity of surface. Contact angles play an important role in determining the permeation flux and anti-fouling property. It is well known that when the contact angle is lower, the material has higher hydrophilicity. As shown in Table 1, incorporation of GO to the PAN matrix causes a significant decrease in contact angle. PAN shows the largest contact angle, 52°. When GO is incorporated (0.5-2%), the contact angle decreases to 49.5−40°. It can be seen from the above results that addition of GO to PAN increases hydrophilicity. It is thought that this results from the oxygen-containing functional groups present on the GO surface. GO having high hydrophilicity moves smoothly towards the surface during phase transition, thereby reducing interfacial energy and enhancing the hydrophilicity of a membrane. In addition, Table 1 shows the effect of GO upon the porosity and average pore diameter of a membrane. It can be seen that incorporation of GO increases both the porosity and average pore diameter of a membrane. GO functions as a nucleating agent during phase separation, and thus increases the membrane growth rate in relation to the film forming mechanism. In addition, the oxygen-containing functional groups have high affinity to water, thereby causing thermodynamic instability in a gelling bath. As a result, exchange between a solvent and a non-solvent is carried out rapidly, resulting in an increase in porosity and pore size.

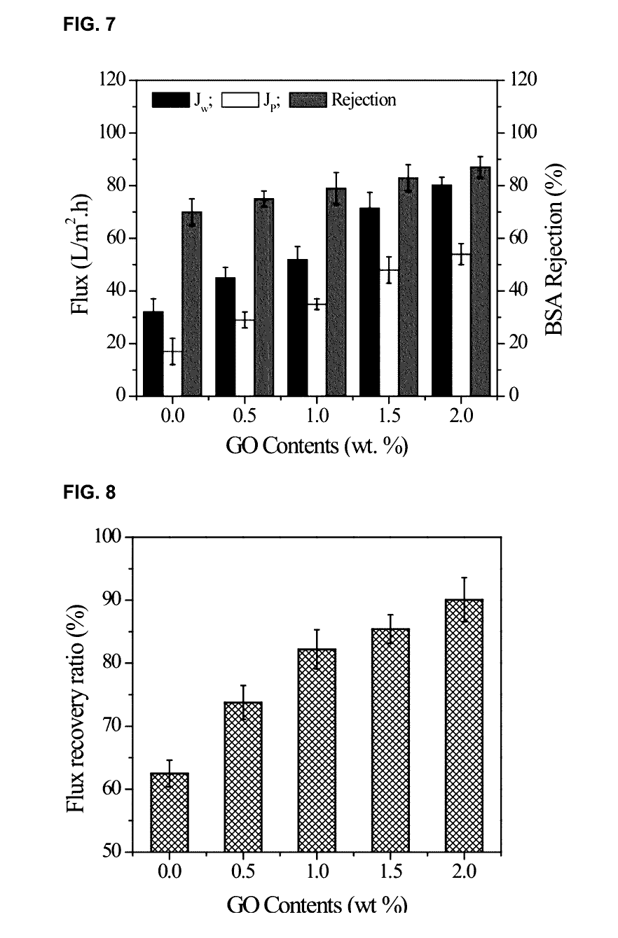

The PAN/GO nanocomposite membranes obtained from the above Example show high porosity, which functions positively in improving the permeability of a membrane. FIG. 7 is a graph illustrating the effect of GO upon a permeation flux and a salt rejection ratio (feed=pure water and 1000 ppm BSA (bovine serum albumin) solution dissolved in PBS (phosphate buffer saline), operating pressure=1 bar). The PAN membrane and PAN/GO nanocomposite membrane are determined for a permeation flux (J_{w1}) of water and a permeation flux (Jₚ)) of BSA solution under a transmembrane pressure difference (TMP) of 0.1 MPa. The error bar is obtained for at least four samples. Both J_{w1} and Jₚ, tend to increase, as GO content increase. When GO content is 2 wt %, J_{w1} reaches the maximum, 80.2 L/m²h, which is approximately twice of the permeation flux of the pure PAN membrane. In this case, Jₚ reaches the maximum, 54 L/m²h, which is approximately twice of the permeation flux of the pure PAN membrane. It is thought that such an increase in permeation flux results from GO, which is a hydrophilic nanomaterial drawing water molecules into the membrane to increase the permeability of water, and from large pores facilitating the permeation of water through the membrane. In addition, the BSA rejection characteristics of the PAN membrane and PAN/GO nanocomposite membrane are investigated. While the PAN membrane shows a rejection ratio of 70%, the PAN/GO nanocomposite membrane shows a higher rejection ratio. It is thought that such a variation in rejection ratio results from a decrease in adsorption of highly hydrophobic BSA onto the modified PAN surface. In other words, water molecules form a layer on the membrane surface to prevent BSA molecules from passing through the membrane.

Further, the PAN/GO nanocomposite membranes obtained from the above Example are tested for anti-fouling properties. Concentration polarization is a main cause of fouling. Concentration polarization is monitored by the two parameters of filtering conditions and surface characteristics of a membrane. In the present disclosure, the same operating conditions are used for all of the membranes. Thus, it is thought that fouling behavior largely depends on the surface characteristics of a membrane. In general, while an ultrafiltration membrane shows a high permeation flux to pure water, the permeation flux decreases rapidly when the feed is changed to BSA solution. The permeation flux decreases rapidly, because BSA molecules remain on the membrane surface due to concentration polarization to form a cake layer. This layer forms a secondary barrier against the flow through the membrane. In order to monitor irreversible fouling of a membrane, the membrane is washed and the permeation flux (J_{w2}) of pure water is measured. To determine variations in permeation flux, flux recovery ratios (FRR) are calculated. The results are shown in FIG. 8. A higher FRR value indicates higher anti-fouling property. In fact, the GO nanocomposite shows a higher FRR as compared to the PAN membrane. The PAN/GO-2.0 nanocomposite membrane shows an FRR of 90% and is highly resistant against fouling. Such results correspond to the test results of contact angles. As the hydrophilicity of surface increases, a larger amount of water is adsorbed onto the surface to form a layer, which inhibits adsorption of hydrophobic protein molecules.

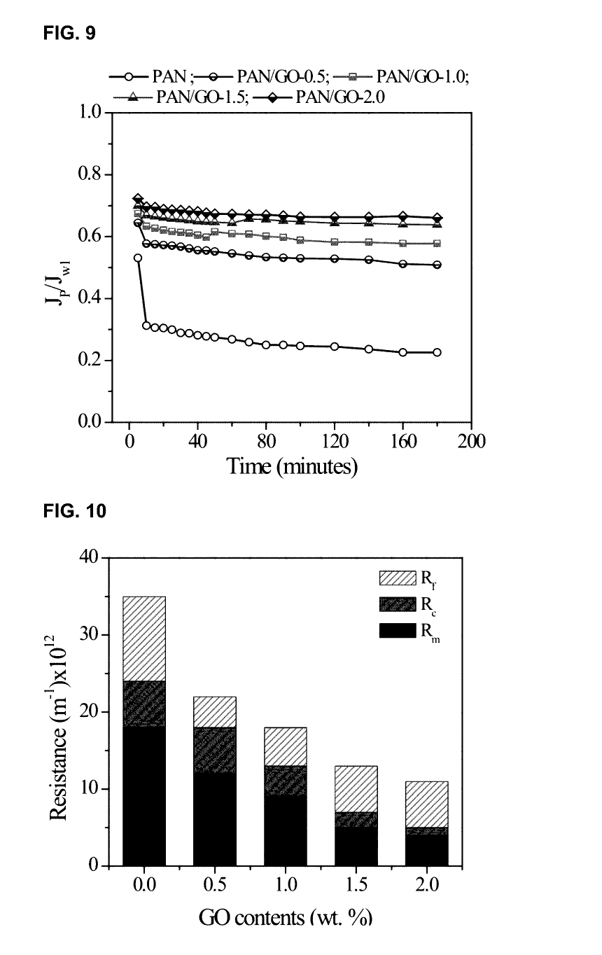

In addition, FIG. 9 shows the results of a test for stability of a membrane against fouling, wherein the ratio of permeation flux (Jₚ) of BSA solution to permeation flux (J_{w1}) of pure water is measured as a function of time. A lower ratio of permeation fluxes indicates higher membrane stability. In the case of the PAN membrane, the ratio of Jₚ to J_{w1} decreases rapidly within the initial 15 minutes and then maintains a stabilized state. In the case of the PAN/GO nanocomposite membranes, the ratio of Jₚ to J_{w1} decreases slightly within the initial 15 minutes and then is maintained constantly. Such a decrease in ratio at the initial time relates with concentration polarization causing the formation of a cake layer. The PAN/GO nanocomposite membranes show a narrow range of caking by virtue of the surface hydrophilicity and repulsion force between the membrane surface and protein.

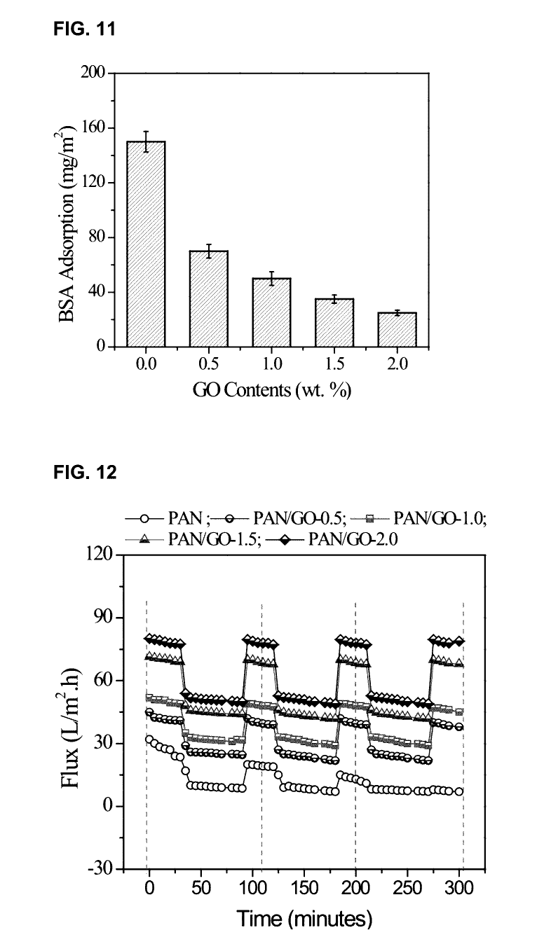

In addition, FIG. 10 is a graph showing the results of filtration resistance analysis for a PAN membrane and PAN/GO nanocomposite membrane, wherein the resistance parameters of membranes, such as fouling resistance (R_{f}), caking resistance (R_{c}) and membrane resistance (Rₘ), are calculated from the permeation fluxes of water before the fouling with BSA and after the washing with water flow. The specific membrane resistance (Rₘ) is reversible membrane resistance caused by adsorption of protein and may be removed easily through washing with water flow. It is noted that as the GO content in a membrane increases, the specific membrane resistance (Rₘ) decreases gradually. The caking resistance (R_{c}) also shows a similar tendency, which is related with loose caking in the PAN/GO nanocomposite membranes by virtue of their high hydrophilicity. The PAN/GO nanocomposite membranes form a more stable hydrated layer by virtue of GO present on the membrane surface, and the layer functions as a steric hindrance against the adhesion of hydrophobic protein to the membrane surface. As a result, it is possible to improve anti-fouling property. The fouling resistance (R_{f}) is irreversible resistance caused by blocking of pores, and is a main factor determining the overall fouling of a membrane from the irreversible adhesion of contaminants on the surface or in the internal pores. Although addition of GO increases R_{f}, R_{f} is still lower as compared to the PAN membrane. It is thought that this is because larger pores are formed in the PAN/GO nanocomposite membranes. Since the PAN/GO nanocomposite membranes show high hydrophilicity, R_{c} is low and BSA adsorption is also low. Such high fouling resistance may also be determined by the electrostatic adsorption of BSA to the membrane surface. FIG. 11 is a graph illustrating the effect of GO upon the electrostatic BSA adsorption in a PAN membrane and PAN/GO nanocomposite membrane. The total amount of BSA adsorbed to the pure PAN membrane is 150 mg/m². However, GO content increases toward the PAN/GO-2.0 membrane, the amount of adsorbed BSA decreases to 25 mg/m². The above results suggest that the resistance of membranes against BSA adsorption is improved, resulting in improved anti-fouling property.

Further, in order to evaluate the effect of GO upon the long-term stability of a membrane, the PAN membrane and PAN/GO nanocomposite membranes are subjected to a filtration cycle test. Three filtration cycles are carried out, wherein each cycle is divided into three steps as shown in FIG. 12. In the first step, pure water is allowed to pass through the membrane for 30 minutes, and then the permeation flux is measured. In the second step, PBS solution containing 1000 ppm of BSA is allowed to pass through the membrane. In the third step, pure water is used to wash the membrane and the permeation flux of pure water is measured for 30 minutes. As mentioned earlier, exchange of pure water with BSA solution causes a significant decrease in permeability of a membrane. However, while the pure PAN membrane causes a decrease in permeation flux of 88%, the PAN/GO-2.0 nanocomposite membrane containing 2 wt % of GO causes a decrease in permeation flux of merely 39%. In all cases, the permeation flux recovery ratios of PAN/GO nanocomposite membranes are maintained at a higher value as compared to the pure PAN membrane. Such results suggest that addition of GO in the PAN/GO nanocomposite membranes not only improves transmembrane permeability related with a permeation flux but also improves stability. The fouling of a membrane is largely affected by the surface roughness of a membrane. The reason why the permeation flux decreases at the initial time is that protein is accumulated at the “valley” portions of the rough membrane surface. In the second cycle, all membranes show a lower permeation flux as compared to the first cycle. It is thought that such a decrease in permeation flux results from protein molecules captured in micropores and blocking channels. Such irreversible pore blocking is not removed by washing of a membrane with water flow. Even after the membrane is washed, the permeation flux of water is not recovered completely. However, as shown in FIG. 12, while the initial permeation flux of the pure PAN membrane decreases continuously, the PAN/GO nanocomposite membranes show an insignificant degree of decrease in permeation flux as compared to the initial permeation flux during three filtration cycles. The above results suggest that while both the pure PAN membrane and PAN/GO nanocomposite membrane are affected by irreversible fouling in terms of permeability, the pure PAN membrane is more susceptible to fouling.

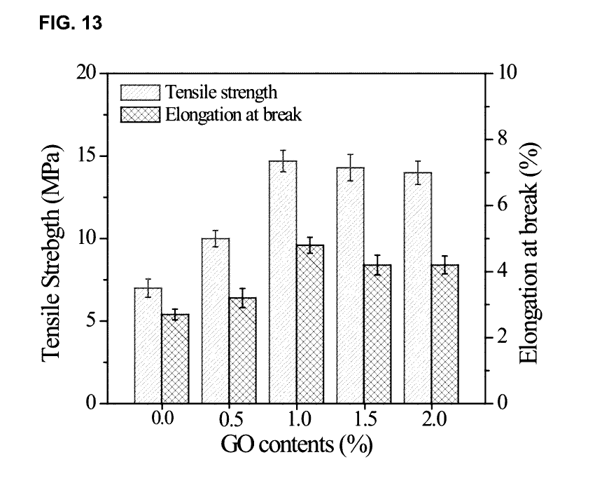

Meanwhile, the mechanical strength of an ultrafiltration membrane is an important factor determining whether a membrane is suitable for commercialization or not. When nanoparticles are added to a polymer matrix, the mechanical stability of the polymer is improved. The interaction between the nanoparticles and polymer causes mass transfer from the polymer to fillers, thereby improving the mechanical stability of a membrane. When adding GO to the PAN membrane, Go not only affects the permeability and fouling property of the membrane but also improves mechanical stability as shown in FIG. 13. It can be seen that addition of GO increases tensile strength significantly. Among the PAN/GO nanocomposite membranes obtained from the above Example, the PAN/GO-1.0 nanocomposite membrane shows the highest increase in tensile strength. As the amount of GO in the polymer matrix increases, tensile strength slightly decreases and deformation at break increases. However, such mechanical properties are still higher as compared to the pure PAN membrane. Such improved mechanical properties result from the interaction of GO containing oxygen and the polymer. When the amount of GO increases more, tensile strength decreases slightly. This may suggest that an increase in pore size adversely affects the mechanical properties of a membrane.

Therefore, the PAN/GO nanocomposite ultrafiltration membrane according to the present disclosure provides improved mechanical properties, has high permeability and a high salt rejection ratio and shows excellent anti-fouling property and durability, and thus may be manufactured in the form of a membrane module applied to a water treatment system so that it may be utilized for an actual ultrafiltration separation process.

What is claimed is:

1. A nanocomposite ultrafiltration membrane, comprising:
a hydrophobic polymer matrix; and
graphene oxide or reduced graphene oxide.

2. The nanocomposite ultrafiltration membrane according to claim 1, wherein the hydrophobic polymer is any one selected from the group consisting of polyacrylonitrile, polysulfone, polyethersulfone, polyimide, polyetherimide, polyamide, cellulose acetate, cellulose triacetate and polyvinylidene fluoride.

3. The nanocomposite ultrafiltration membrane according to claim 1, wherein the graphene oxide or reduced graphene oxide is present in an amount of 0.1 wt %-10 wt % based on the total weight of the nanocomposite ultrafiltration membrane.

4. The nanocomposite ultrafiltration membrane according to claim 1, wherein the graphene oxide is functionalized graphene oxide whose hydroxyl, carboxyl, carbonyl or epoxy group is converted into an ester, ether, amide or amino group.

5. A method for preparing a nanocomposite ultrafiltration membrane, comprising the steps of:
I) adding graphene oxide to an organic solvent and carrying out ultrasonication to obtain a homogenous dispersion;
II) dissolving a hydrophobic polymer into the dispersion to obtain a casting solution; and
III) casting the casting solution onto a substrate and dipping the substrate into a solidification bath to carry out phase transition.

6. The method for preparing a nanocomposite ultrafiltration membrane according to claim 5, wherein the graphene oxide is functionalized graphene oxide whose hydroxyl, carboxyl, carbonyl or epoxy group is converted into an ester, ether, amide or amino group.

7. The method for preparing a nanocomposite ultrafiltration membrane according to claim 5, wherein the organic solvent is any one selected from the group consisting of dimethylformamide, dimethylacetamide, N-methylpyrrolidone, dimethyl sulfoxide and a mixture thereof.

8. The method for preparing a nanocomposite ultrafiltration membrane according to claim 5, wherein the hydrophobic polymer is any one selected from the group consisting of polyacrylonitrile, polysulfone, polyethersulfone, polyimide, polyetherimide, polyamide, cellulose acetate, cellulose triacetate and polyvinylidene fluoride.

9. The method for preparing a nanocomposite ultrafiltration membrane according to claim 5, wherein the casting solution comprises graphene oxide in an amount of 0.1 wt %-10 wt %.

10. The method for preparing a nanocomposite ultrafiltration membrane according to claim 5, wherein the solidification bath comprises at least one non-solvent selected from the group consisting of water, methanol, ethanol, isopropanol and acetone.

11. The method for preparing a nanocomposite ultrafiltration membrane according to claim 5, which further comprises treating the graphene oxide in step I) chemically or thermally to obtain reduced graphene oxide.

12. The method for preparing a nanocomposite ultrafiltration membrane according to claim 11, wherein the chemical treatment of graphene oxide is carried out by reacting graphene oxide with any one reducing agent selected from the group consisting of hydrazine, dimethyl hydrazine, sodium borohydride, hydroquinone and hydrogen iodide.

13. A spirally wound type membrane module comprising the nanocomposite ultrafiltration membrane as defined in claim 1.

14. A water treatment system comprising the spirally wound type membrane module as defined in claim 13.
